(19) United States
(12) Patent Application Publication
(10) Pub. No.: US 2024/0407353 A1
(43) Pub. Date: Dec. 12, 2024

(54) A TRAP FOR RODENTS AND METHOD OF CATCHING AND PREFERABLY KILLING A RODENT

(71) Applicant: SWISSINNO SOLUTIONS AG, St. Gallen (CH)

(72) Inventor: Silvin JANCIC, Villmergen (CH)

(73) Assignee: SWISSINNO SOLUTIONS AG, St. Gallen (CH)

(21) Appl. No.: 18/720,262

(22) PCT Filed: Dec. 14, 2021
(86) PCT No.: PCT/EP2021/085586

§ 371 Date: Jun. 14, 2024

(51) Int. Cl. A01M 23/30

(52) U.S. Cl. CPC A01M 23/30

(57) ABSTRACT

A trap for rodents including a base having a plane, a pivotable hammer bar having at least one latch connecting element, a lever element including a rodent positioning member and at least one latch member, wherein the lever element has a longitudinal axis and the rodent position member and the latch member are arranged opposing ends of the lever element with respect to the longitudinal axis, a spring element for pretensioning the hammer bar and at least one latch hook. The pivotable hammer bar and the lever element have a striking position and an arming position. In the arming position the hammer bar is pretensioned by the spring element and the at least one latch member retains the hammer bar in its position. In the arming position the hammer bar is latched under the latch hook at the latch connecting element. The rodent position member is liftable from the arming position into the striking position.

The invention concerns a trap for rodents and a method for catching and preferably killing a rodent.

Generally, rodent traps for catching and killing rodents are known from the prior art. There are traps such as the trap disclosed in U.S. Pat. No. 4,991,340 which comprises two opposing parts which are activated when a rodent steps on the trigger. Those kinds of mouse traps have the disadvantage that they can be activated accidentally and could even catch birds or other animals when they step on the trigger. There are also traps such as the trap disclosed in WO 2010/022779 A1, which comprises a pivotable bar which is pivoted when a rodent steps on a trigger. Those kind of mouse traps have the disadvantage that they have to be armed in two steps by pivoting the pivotable bar and arranging and fixing a bracket across the pivotable bar to keep it in position. For this reason, arming such a mouse trap in two steps is complicated and time consuming.

It is therefore an object of the present invention to create a trap for rodents, which overcomes the disadvantages of the prior art and in particular create a trap for rodents which is easy and safe to use.

The object is achieved by a trap for rodents and a method for catching and preferably killing a rodent according to the independent claims.

The object is particularly achieved by a trap for rodents comprising a base having a base plane, a pivotable hammer bar having at least one latch connecting element, a lever element comprising a rodent positioning member and at least one latch member.

The lever element comprises a longitudinal axis wherein the rodent positioning member and the latch member are arranged on opposing ends of the lever element with respect to the longitudinal axis. The trap for rodents also comprises a spring element for a pre-tensioning the hammer bar and at least one latch hook. The pivotable hammer bar and the lever element have a striking position and an arming position. In the arming position the hammer bar is pre-tensioned by the spring element and the at least one latch member retains the hammer bar in its position. The hammer bar is latched under the latch hook at the latch connecting element. The rodent positioning member is liftable from the arming position into the striking position.

Such a trap for rodents is easy to use and can be armed in one move using just one hand, which makes it very convenient.

The pivotable hammer bar is pivotable from the arming position into the striking position. In this movement, the pivotable hammer bar is powered by the spring element. The fact that the rodent positioning member is liftable from the arming position in the striking position makes it very unlikely that the trap for rodents is triggered accidentally by other animals such as birds.

The pivotable hammer bar can be positioned by a user in the arming position. This can easily be achieved in one movement. When the pivotable hammer bar is positioned by a user in the arming position, the spring element is pre-tensioned. The trap comprises at least one latch hook. The trap for rodents can also comprise two or even more latch hooks. The latch hook and the lever element are preferably made from plastic material. They can also be made from metal or wood or another material. The pivotable hammer bar is preferably made from metal, in particular steel. It can also be made from other materials. The pivotable hammer bar can also be made from a wire which is bent into the desired shape. The base is preferably made from wood. The base can also be made from plastic, metal, steel or another material. The spring can be made from spring metal, in particular spring steel. The spring can also be made from another metal or nonmetal material such as rubber. The trap can alternatively comprise more than one spring, such as two or more. The lever element can have a length of 4 cm to 12 cm for a mouse or a rat trap.

The latch connecting element can comprise a longitudinal section which is essentially parallel to the longitudinal axis of the lever element when the hammer bar is in the arming position.

According to the invention essentially parallel to the longitudinal axis means parallel in one dimension. The height dimension perpendicular to the base plane does not necessarily need to be parallel but can have a deviation of up to about 45° preferably up to about 20°. Such a trap is easy to handle. The latch connecting element can be made from the same material which the hammer bar is made of. It is possible that the hammer bar is made from a bent wire and the latch connecting element is a part of the wire. The latch connecting element can be an integral part of the hammer bar.

The hammer bar can comprise at least a first section and a second section wherein the second section is arranged between the first section and the spring element and wherein the first section comprises the latch connecting element.

Thus, the latch connecting element is arranged at a distance to the spring and can therefore easily be connected to the latch hook.

The first section can have the same extent in the longitudinal direction as the second section. The first section may also have a smaller extent in the longitudinal direction than the second section, for example one-third or one-quarter of the extent in direction of the longitudinal axis of the lever element (in the arming position).

The first section can be essentially U-shaped.

The U-shaped first section is easy to produce and easy to handle. A U-shaped first section can be produced by bending. When the hammer bar is made from wire, the complete hammer bar comprising the first section, the second section and the latch connecting element can easily, quickly and efficiently be produced by bending the wire. The hammer bar can also be moulded out of plastic. Also in this case, the first section can be U-shaped.

The second section can have larger expansion perpendicular to the longitudinal axis of the lever element than the first section.

This enables a slim design of the whole trap.

The first section can have an expansion perpendicular to the longitudinal axis of the lever element which is less than 50%, preferably less than 30%, most preferably less than 20%, of the expansion of the second section perpendicular to the longitudinal axis of the lever element.

The rodent positioning member can have an at least partially rounded, conical or cylindrical shape. The rodent positioning member can also have an at least partially rounded conical or cylindrical hollow shape. The rodent positioning member may also comprise one or more flat sides.

The rodent positioning member guides the rodent into the correct position to activate the trap and hitting the rodent in the right spot to instantly killing the rodent without any pain. For this purpose, the rodent positioning member is adapted to the snout of a rodent and has preferably at least partially rounded conical or cylindrical shape. In this way the rodent easily fits into the rodent positioning member for activating the trap.

The rodent positioning member can be at least partially open in the direction of the base forming an access cavity.

In this way it is likely that the rodent in order to reach the bait by accessing the access cavity lifts the rodent positioning member, so the trap is activated and the hammer bar pivots from the arming position into the striking position. This makes the rodent trap reliable and very unlikely to fail. The access cavity can be partially rounded. The decisive factor is that the access cavity is formed in a way that a rodent can enter it with its nose and thereby lifts the rodent positioning member for activating the trap.

The at least one latch hook can comprise a hooking section comprising a hooking surface having at least one hooking-surface-plane. The hooking-surface-plane can be arranged at an angle relative to the plane of the base wherein the angle is substantially more than 10° respectively less than 170°, in particular more than 15°, respectively less than 165°.

This way it is necessary to position the latch member in the arming position to keep the pivotable hammer bar in the arming position at the latch hook. This makes the pivotable hammer bar pivot quickly and easily when a rodent lifts the rodent positioning member of the lever element from the arming position into the striking position. The angle depends on the material combination of the latch hook and the latch connecting element and the resulting friction between those elements. Therefore, the hooking surface of the hooking section can preferably be smooth.

It is also possible that the hooking surface is rounded. The hooking surface can also comprise angles or two or more radiuses. The hooking surface can also be rounded in different directions.

The at least one latch hook can also comprise a first hammer bar inserting surface. The first hammer bar inserting surface can comprise a plane wherein the first hammer bar inserting surface plane is arranged at an inserting angle relative to the hooking surface plane, wherein the inserting angle is arranged of 30° to 90°.

Such a first hammer bar inserting surface of the latch hook makes it very easy to insert the hammer bar into the latch hook and therefore position the hammer bar into the arming position. That makes it very comfortable for the user to use and especially set the trap.

The trap for rodents can comprise at least two latch hooks.

The trap comprising two latch hooks fits very well to the U-shaped form of the first section of the hammer bar. The U-shaped form comprises two latch connecting elements. The U-shaped of the hammer bar is latched under at least one latch hook at one latch connecting element. It is also possible that the U-shaped hammer bar is latched under the latch hooks at two connecting elements. At least one of the two latch connecting elements is latched by the latched element of the lever element.

The object of the invention is also achieved by a method for a catching and preferably killing rodent. The method comprises the step of positioning a trap as described before wherein the trap is positioned in the arming position and the hammer bar pivots into the striking position when the rodent lifts the rodent position member.

The method is easy, reliable and efficient.

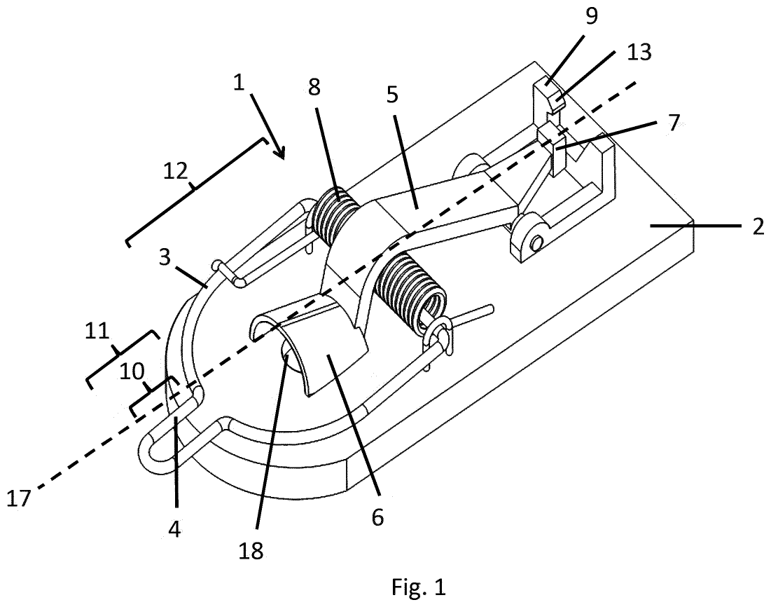

FIG. 1: A trap for rodents in the striking position,

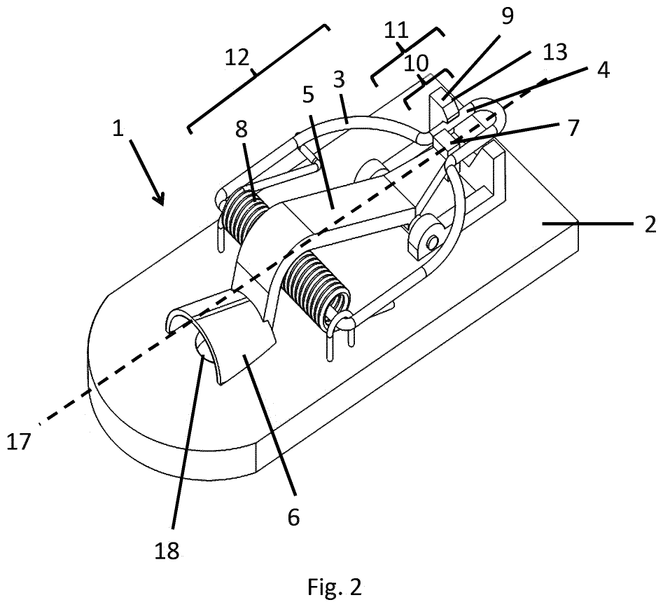

FIG. 2: a trap for rodents in the arming position,

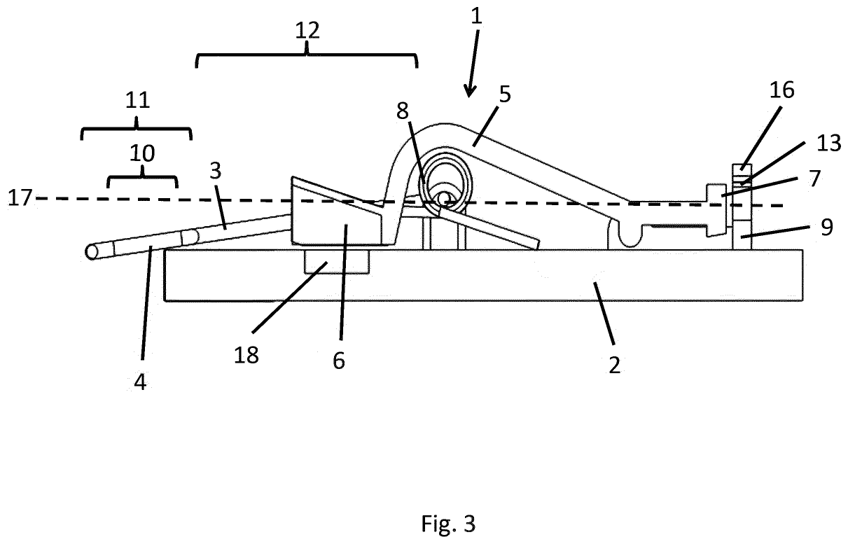

FIG. 3: a longitudinal cut through a trap for rodents in the striking position,

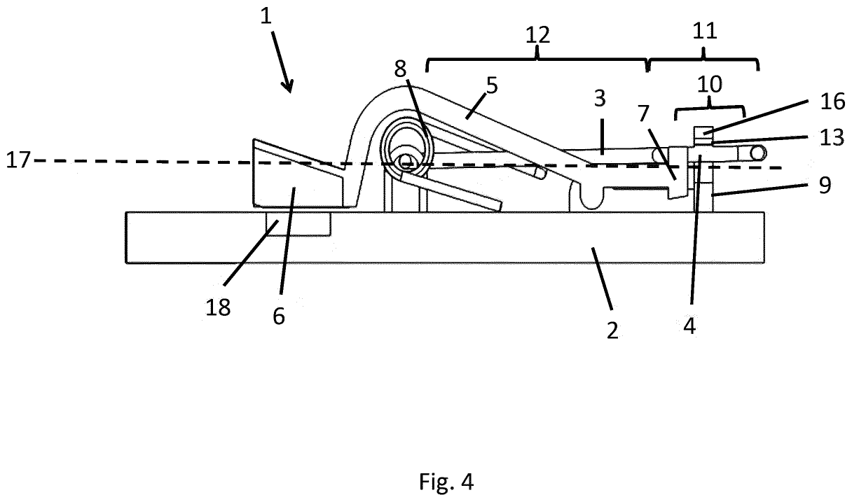

FIG. 4: a longitudinal cut through a trap for rodents in the arming position,

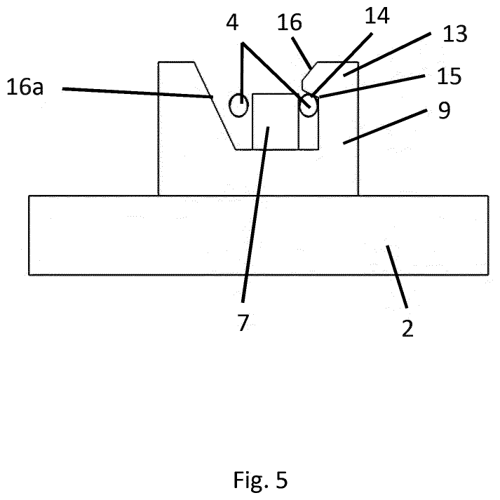

FIG. 5: a latch hook, a hammer bar and a lever element in the arming position,

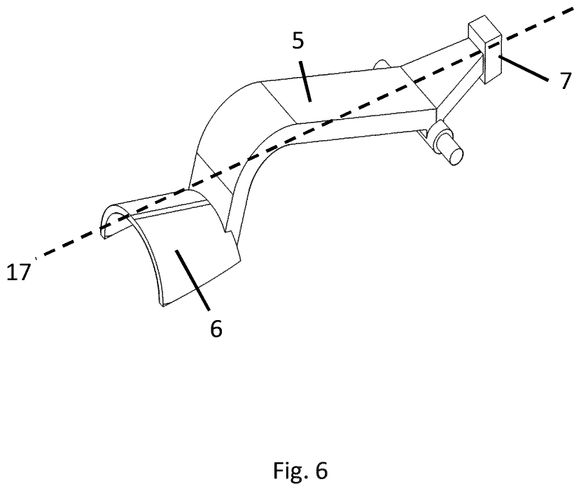

FIG. 6: a lever element with a rodent positioning member and a latch member,

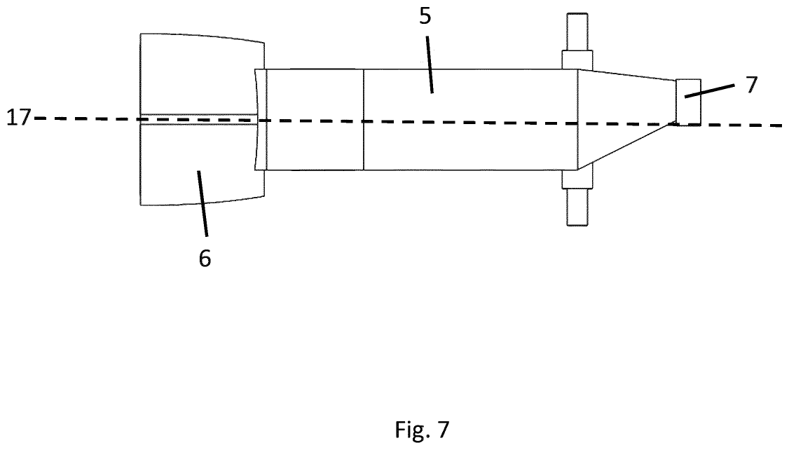

FIG. 7: a top view of a lever element with a rodent positioning member and latch member,

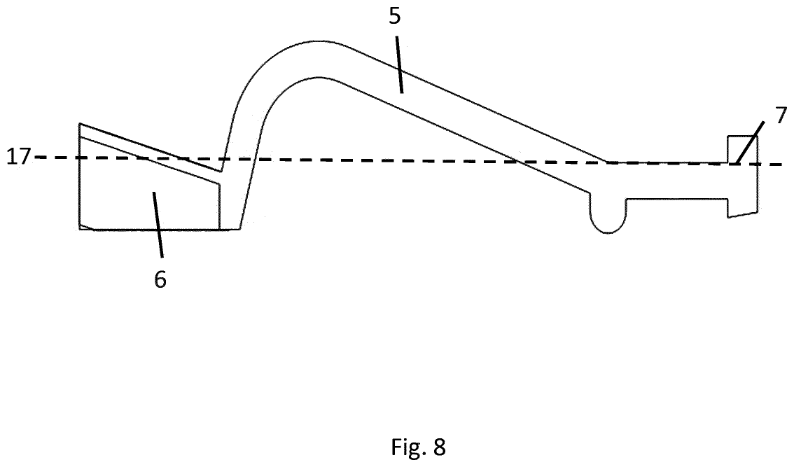

FIG. 8: a longitudinal cut through the lever element with a latch member and a spring element, and

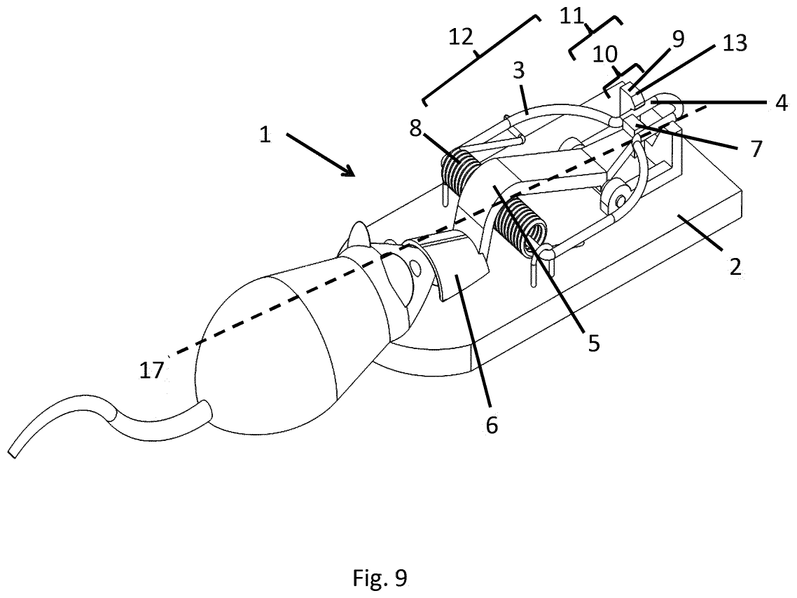

FIG. 9: a trap for rodents in the arming position with a rodent.

FIG. 1 shows a trap for rodents in the striking position. The hammer bar 3 comprises a latch connecting element 4. The pivotable hammer bar 3 also comprises a longitudinal section 10, a first section 11 and a second section 12. The latch connecting element 4 of the hammer bar 3 is U-shaped. The trap 1 for rodents comprises a spring element 8. The spring element 8 is designed as a spiral spring. The trap 1 for rodents also comprises a base 2. The base 2 comprises a bait container 18. Further the trap 1 for rodents comprises a latch hook 9 with a hooking section 13. Furthermore, the trap 1 for rodents comprises a lever element 5 with a rodent position member 6 and a latch member 7. The lever element 5 has a longitudinal axis 17. The rodent positioning member 6 and the latch member 7 are arranged on opposing ends of the lever element 5 with respect to the longitudinal axis 17. The rodent position member 6 is formed partially rounded as a hollow shape and open in the direction of the base 2 forming an access cavity. The hammer bar 3 is tensioned against the base 2 by the spring element 8 in the shown striking position. The latch member 7 is designed as a cuboid.

FIG. 2 shows a trap 1 for rodents in the arming position. The pivotable hammer bar 3 is in the arming position. In the arming position, the pivotable hammer 3 bar is pretensioned by the spring element 8. In the arming position the latch member 7 retains the hammer bar 3 in its position. The hammer bar 3 is alleged under the latch hook 9 at the latch connecting element 4. The base 2 comprises a bait container 18.

FIG. 3 shows a longitudinal cut through a trap 1 for rodents in the striking position. The trap 1 for rodents comprises a base 2 and a pivotable hammer bar 3. The base 2 comprises a bait container 18. The pivotable hammer bar 3 comprises a latch connecting element 4, a longitudinal section 10, a first section 11 and a second section 12. In the shown striking position the hammer bar 3 is pretensioned against the base 2 by the spring element 8. The spring element 8 is designed as a spiral spring. The rodent positioning member 6 is designed as a hollow shape which is open in the direction of the base 2 forming an access cavity. Under the rodent positioning member 6 there is a bait area arranged. The rodent positioning member 6 is formed in a way such that a rodent can enter the rodent positioning member 6 with the nose and lift the rodent positioning member 6 from the arming position to the striking position.

FIG. 4 shows a longitudinal cut through a rodent trap 1 in the arming position. The pivotable hammer bar 3 is arranged in the arming position, the latch connecting element 4 of the pivotable hammer bar 3 is latched by the latch hook 9. The latch connecting element 4 is arranged in the first section 11 of the pivotable hammer bar 3. The second section 12 of the pivotable hammer bar 3 is arranged between the spring element 8 and the first section 11 of the pivotable hammer bar 3. The pivotable hammer bar 3 is arranged under the latch hook 9 with the latch connecting element 4. The base 2 comprises a bait container 18.

FIG. 5 shows a latch hook 9, a hammer bar 3 and a lever element 7 in the arming position. The hammer bar 3 comprises a latch connecting element 4. The pivotable hammer bar 3 is hooked with the latch connecting element 4 under the latch hook 9. The latch hook 9 comprises a hooking section 13. The hooking section 13 comprises a hooking surface 14, an angle 15 and a first hammer bar inserting surface 16. The latch member 7 retains the latch connecting element 4 of the hammer bar 3. The angle is approximately 20°. It is necessary to position the latch member 7 in the arming position to keep the pivotable hammer bar 3 in the arming position. The first hammer bar inserting surface 16 is arranged in an inserting angle relative to the hooking surface plane 14 wherein the inserting angle is approximately 75°. The latch hook comprises a second hammer bar inserting surface (16a). The second hammer bar inserting surface is arranged in way that makes it easy to push the latch connecting element (4) under the hooking surface (14).

FIG. 6 shows a lever element 5 with a rodent positioning member 6 and a latch member 7. The lever element comprises a longitudinal axis 17. The rodent position member 6 and the latch member 7 are arranged in opposing ends of the lever element 5 with respect to the longitudinal axis 17 of the lever element 5. The latch member 7 is designed as a cuboid. The rodent position member 6 is designed partially rounded with a hollow shape which is open in the direction of the base forming an access cavity for the rodent.

FIG. 7 shows a top view of a lever element 5 with a rodent positioning member 6 and a latch member 7. The lever element 5 comprises a rodent position member 6 and a latch member 7. The latch member 7 is formed as a cuboid. The rodent position member 6 is formed partially rounded with a hollow shape which is at least partially open in the direction of the base forming an access cavity.

FIG. 8 shows a lever element 5 in a longitudinal cut. The lever element 5 comprises a rodent position member 6 and a latch member 7. The latch member 7 is formed as a cuboid. The rodent position member 6 is formed rounded in a hollow shape which is open in the direction of the base forming an access cavity. The lever element 5 has a longitudinal axis 17. The rodent position member 6 and the latch member 7 are arranged on opposing ends of the lever element 5 with respect to the longitudinal axis 17.

FIG. 9 shows a trap 1 for rodents in the arming position. The hammer bar 3 is pretensioned by the spring element 8 and the hammer bar 3 is hooked under the latch hook 9 and retained by the latch member 7. The rodent accesses the access cavity of the rodent position member 6. The rodent position member 6 is formed in a way such the rodent can reach the bait area just by accessing the access cave of the rodent positioning member 6 in a direction which is essentially parallel to the longitudinal axis 17 of the lever element 5. In this way the rodent lifts the rodent positioning member 6 from the arming position into the striking position. When the rodent position member 6 is lifted by the rodent from the arming position in the striking position, the latch member 7 turns down from the arming position to the striking position and the pivotable hammer bar 3 is released. The latch connecting element 4 of the pivotable hammer bar 3 moves under the latch hook 9 and the hammer bar 3 turns from the arming position into the striking position. In the striking position, the hammer bar hits the rodent and is also pretensioned against the rodent by the spring element 8.

1. A trap for rodents comprising a base having a base plane, a pivotable hammer bar having at least one latch connecting element, a lever element comprising a rodent positioning member and at least one latch member, wherein the lever element comprises a longitudinal axis wherein the rodent positioning member and the latch member are arranged on opposing ends of the lever element with respect to the longitudinal axis, a spring element for pre-tensioning the hammer bar, and at least one latch hook,
wherein the pivotable hammer bar and the lever element have a striking position and an arming position,
wherein in the arming position the hammer bar is pretensioned by the spring element and the at least one latch member retains the hammer bar in its position and the hammer bar is latched under the latch hook at the latch connecting element, characterized in that the rodent positioning member is liftable from the arming position into the striking position.

2. The trap according to claim 1, wherein the latch connecting element comprises a longitudinal section, which is essentially parallel to the longitudinal axis of the lever element when the hammer bar is in the arming position.

3. The trap according to claim 2, wherein the hammer bar comprises at least a first section and a second section, wherein the second section is arranged between the first section and the spring element, wherein the first section comprises the latch connecting element.

4. The trap according to claim 3, wherein the first section is essentially U-shaped.

5. The trap according to claim 3, wherein the second section has a larger expansion perpendicular to the longitudinal axis of the lever element than the first section.

6. The trap according to claim 1, wherein the rodent positioning member has an at least partially rounded, conical, or cylindrical shape, preferably at least partially rounded, conical, or cylindrical hollow shape.

7. The trap according to claim 6, wherein the rodent positioning member is at least partially open in the direction of the base forming an access cavity.

8. The trap according to claim 1, wherein the at least one latch hook comprises a hooking-section comprising a hooking-surface having at least one hooking-surface-plane, wherein the hooking-surface-plane is arranged at an angle relative to the plane of the base wherein the angle is substantially more than 10°, respectively less than 170°, in particular more than 15°, respectively less than 165°.

9. The trap according to claim 8, wherein the at least one latch hook comprises a first hammer-bar-inserting-surface with a plane, wherein the first hammer-bar-inserting-surface plane is arranged at an inserting angle relative to the hooking-surface-plane wherein the inserting angle is in a range of 30°-90°.

10. The trap according to claim 1, comprising at least two latch hooks.

11. A method for catching and preferably killing a rodent comprising the step of positioning a trap according to claim 1, wherein the trap is positioned in the arming position and the hammer bar pivots into the striking position when a rodent lifts the rodent positioning member.
